(19) United States
(12) Patent Application Publication
(10) Pub. No.: US 2008/0243823 A1
(43) Pub. Date: Oct. 2, 2008

(54) System and method for automatically generating information within an eletronic document

(75) Inventors: Russell Baris, Westport, CT (US); Arthur Kruk, Stamford, CT (US)

Correspondence Address: AMSTER, ROTHSTEIN & EBENSTEIN LLP, 90 PARK AVENUE, NEW YORK, NY, 10016, US

(73) Assignee: eLumindata, Inc.

(21) Appl. No.: 11/729,373

(22) Filed: Mar. 28, 2007

(51) Int. Cl. G06F 7/00; G06F 15/00; G06F 17/00; G06F 17/30

(52) U.S. Cl. 707/5; 715/212; 715/230; 715/255

(57) ABSTRACT

A method for automatically generating target information within an electronic document including the steps of: retrieving term-based identifying information from the electronic document that specifies the target information to be generated; accessing rules associated with generation of the target information based on the retrieved term-based identifying information; analyzing the identifying information and the rules to identify a type of target information to be generated and a formula that uses underlying data to generate the target information; automatically generating data source instructions based on the type of target information to be generated and the formula; and automatically processing the data source instructions to generate the target information within the electronic document.

### TECHNICAL FIELD

The present invention is generally related to systems and methods for generating information within an electronic document.

### BACKGROUND

Conventional spreadsheet software, such as Visicalc, Lotus 1-2-3 and Excel, although useful tools, are rather simplistic in their implementation. For example, if a user creates a row of cells containing the months of the year, the user is aware that each column represents one month's advance in time, but the software does not. On the contrary, the software is only aware of the data stored in each cell, and the formulas manually entered into the cells by the user requiring manipulation of data between the cells, and has no intelligence regarding the significance of the data to the overall context.

Common alternatives to conventional spreadsheet software include financial modeling software and BI (Business Intelligence) products with online analytical processing (also known as OLAP) database architecture. These products generally use databases which have been structured to improve performance of specific types of queries. These products are also known for providing “Dashboard” views of business operations performance. However, these products require information technology professionals to design, construct and maintain specialized databases. The information provided to business decision makers is therefore costly to acquire and difficult to change as new questions are considered. OLAP and BI were not designed so that business users can independently define terms and relationships describing the business.

Text Mining is a category of analytic software which analyzes unstructured text and develops scores based on usage frequency. For example, an automobile manufacturer could rank component failure areas based on the text of customer complaints. While this software enables users to store relationships among like terms, such as “brakes” with “brake pads” and “rotors”, the software does not offer the capability to associate other available business data or formulas with these terms.

Because conventional spreadsheet software has limited knowledge of the structure of data, the user needs to be heavily involved in creating models with the data. Further, it is often difficult to audit and verify a worksheet model, as the formulas often haphazardly reference cells all over the worksheet. Also, once a model is built, it is often difficult to modify the model to correct errors or incorporate new assumptions and features. Conventional spreadsheet software also has very limited ability to access databases to retrieve necessary data.

To remedy some of the problems associated with older spreadsheet software, multiple analytical tools were created. In the 1980's, for example, Javelin and Express were developed. Javelin software works with variables instead of cells, where a variable can be a single entry, called a constant. Most often the variable is a time series, that is, an observation (such as sales or costs) that varies over time. With Javelin, a user can define a variable with formulas, so that, for example, a monthly variable called “Bakery Sales Tax” can be set as “0.06*Bakery Sales”. Then, if that formula is copied to another variable called “Deli Sales Tax”, Javelin would automatically set the formula for “Deli Sales Tax” to “0.06*Deli Sales” by substituting “Deli” for “Bakery”.

Although Javelin represented an advancement over more conventional spreadsheet software in that, for example, it allows the user to save calculations independently from individual cells, it still requires the user to perform the cumbersome task of inputting data and appropriate formulas. A new generation of financial modeling tools, such as the Quantrix Modeler, available from Quantrix of Portland, Me., employs single formulas that calculate values for multiple cells using appropriately adjusted data. Because changes to data can be made globally rather than on a cell-by-cell basis, software such as Javelin and Quantrix provide some diminishment in the risk of error inherent in more conventional spreadsheet software, such as Excel. However, as with the more conventional software, both Javelin and Quantrix require user input of data and formulas.

Most recently, Microsoft Excel “2007” offers the added functionality of displaying labels for data as previously stored in a database designed for online analytical processing (also known as OLAP), and displaying multiple levels of aggregation for data which can be aggregated by previously defined criteria, such as employees working in a common department or division. This software and similar products such as the business analysis products from Hyperion and Outlooksoft are limited to reporting categorizations and aggregations which were previously defined in OLAP or conventional databases. If the user attempts to use data from these defined associations in new or separate computations, the user must refer back to the original positional reference in a spreadsheet for each of the data elements. If the user wishes to create new computations or reports with these data elements, the logical or “business” purpose of the data is not carried forward into the a new calculation, only the value. Thus the data integrity, and potential for reuse of data relationships as the original data sources are updated, are extremely fragile.

Accordingly, there is a need for a method and system for generating information within an electronic document, such as a spreadsheet, that is able to function intelligently with the inherent structure of the underlying data within the electronic document so that minimal user interaction is required for the generation of the information.

### SUMMARY OF THE INVENTION

A method for automatically generating information within an electronic document according to an exemplary embodiment of the invention comprises the steps of: retrieving term-based identifying information from the electronic document that specifies the target information to be generated; accessing rules associated with generation of the target information based on the retrieved term-based identifying information; analyzing the identifying information and the rules to identify a type of target information to be generated and a formula that uses underlying data to generate the target information; automatically generating data source instructions based on the type of target information to be generated and the formula; and automatically processing the data source instructions to generate the target information within the electronic document.

According to an exemplary embodiment of the invention, a computer readable medium has computer executable instructions for performing a method for automatically generating information within an electronic document, and the method comprises the steps of: retrieving term-based identifying information from the electronic document that specifies the target information to be generated; accessing rules associated with generation of the target information based on the retrieved term-based identifying information; analyzing the identifying information and the rules to identify a type of target information to be generated and a formula that uses underlying data to generate the target information; automatically generating data source instructions based on the type of target information to be generated and the formula; and automatically processing the data source instructions to generate the target information within the electronic document.

In at least one embodiment, a preferred source of the underlying data is determined, and the data source instructions are also based on the preferred source.

In at least one embodiment, the step of determining a preferred source of the underlying data comprises accessing metadata from one or more potential sources of the underlying data, and analyzing the metadata to identify the preferred source of the underlying data.

In at least one embodiment, the electronic document is a spreadsheet and the identifying information comprises at least one of a row header and a column header from the spreadsheet.

In at least one embodiment, the rules comprise one or more of following: an equation, a data condition, format and scaling instructions, unit of measure conversions and synonym rules.

In at least one embodiment, the preferred source of the underlying data is located on the Internet.

In at least one embodiment, the preferred source of the underlying data is a database.

In at least one embodiment, the method further comprises automatically generating an identification code corresponding to the term-based identifying information and the generated data source instructions.

In at least one embodiment, the method further comprises storing the generated identification code and its corresponding term-based identifying information and generated data source instructions so as to be accessible to generate data source instructions for generating other information within the electronic document that has the same term-based identifying information.

In at least one embodiment, the step of analyzing the identifying information, the metadata and the rules to identify a type of information to be generated, a preferred source of the underlying data and a formula to be used to process the underlying data comprises prioritizing the one or more potential sources of underlying data based on likelihood of providing appropriate underlying data.

In at least one embodiment, the step of prioritizing comprises determining whether data in each of the potential sources of underlying data is at a required level of aggregation.

In at least one embodiment, the step of prioritizing comprises determining whether data in each of the potential sources of underlying data can be aggregated to obtain a required level of aggregation.

In at least one embodiment, the rule comprises an equation, and the equation applies to a particular context.

In at least one embodiment, the rule comprises an equation, and the equation applied to a particular scenario.

A system for automatically generating target information within an electronic document according to an exemplary embodiment of the present invention comprises: a header manager that retrieves term-based identifying information from the electronic document that specifies the target information to be generated; a term manager that accesses rules associated with generation of the target information based on the retrieved term-based identifying information; a derivation engine that analyzes the identifying information and the rules to identify a type of target information to be generated and to determine a formula that uses underlying data to generate the target information; a query manager that automatically generates data source instructions based on the type of target information to be generated and the formula; and a display manager that automatically processes the data source instructions to generate the target information within the electronic document.

In at least one embodiment, the system further comprises a database manager that accesses one or more databases to retrieve underlying data based on the data source instructions.

In at least one embodiment, the database manager is an element of the query manager.

In at least one embodiment, the system further comprises a relationship manager that stores relationship rules among the underlying data.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a flow chart showing a method for generating target information within an electronic document using identifying information contained within the electronic document;

FIG. 2A-J show portions of sales spreadsheets and corresponding cell header tables and target source arrays generated using the method of generating target information within an electronic document according to an exemplary embodiment of the present invention;

FIG. 3 is a block diagram showing a system for generating an intelligent interface according to an exemplary embodiment of the present invention;

FIG. 4 is a flowchart showing a method for generating cell data within a spreadsheet according to cell header information contained within the spreadsheet according to an exemplary embodiment of the present invention;

FIG. 5A is a flowchart showing a method for filling in a cell header table according to an exemplary embodiment of the present invention, as a sub-routine of the method of FIG. 4;

FIG. 5B is a flowchart showing a method for filling in a cell header table according to an exemplary embodiment of the present invention, as a sub-routine of the method of FIG. 4;

FIG. 6 is a flowchart showing a method for filling in a cell header table row according to an exemplary embodiment of the present invention, as a sub-routine of the method of FIG. 4;

FIG. 7 is a flowchart showing a method for determining a cell ID according to an exemplary embodiment of the present invention, as a sub-routine of the method of FIG. 4;

FIG. 8 shows a determination of a cell ID for an exemplary cell header table;

FIG. 9 is a flowchart showing a method for setting a source to display manager according to an exemplary embodiment of the present invention, as a sub-routine of the method of FIG. 4;

FIG. 10 shows an example of setting a source to display manager;

FIG. 11 is a flowchart showing a method of converting scenario terms and resorting cell headers according to an exemplary embodiment of the present invention, as a sub-routine of the method of FIG. 4;

FIG. 12 is a flowchart showing a method of converting formula rules to a formula according to an exemplary embodiment of the present invention, as a sub-routine of the method of FIG. 4;

FIG. 13 is a flowchart showing a method of generating intermediates for a source array according to an exemplary embodiment of the present invention, as a sub-routine of the method of FIG. 4;

FIG. 14 is a flowchart showing a method for determining a data source according to an exemplary embodiment of the present invention, as a sub-routine of the method of FIG. 4; and

FIG. 15 is a flowchart for determining format and sending to display manager according to an exemplary embodiment of the present invention, as a sub-routine of the method of FIG. 4.

### DETAILED DESCRIPTION OF PREFERRED EMBODIMENTS

The present invention is directed to a system and method for generating target information within an electronic document based on identifying information contained within the electronic document. As used herein, the term “target information” refers to information that is being sought as input to the electronic document, and the term “identifying information” refers to term-based information within an electronic document that identifies the target information to be generated. For example, if the underlying electronic document is a spreadsheet, the identifying information may be the terms in a column header and a row header which correspond to a blank cell within the spreadsheet, or if the underlying electronic document is a webpage, the identifying information may be terms within the webpage that form a query. Thus, altering the identifying information within the electronic document will result in corresponding modification of the target information. As will be shown in more detail below, this “on the fly” generation of target information results in a quick and efficient way for users of software and/or hardware implementing the method to obtain and review analyzed data.

According to an exemplary embodiment of the present method, a user identifies data values (as target information) to be determined in a spreadsheet by entering a combination of column, row and table headers (as identifying information) into the spreadsheet, and the data values are automatically determined by referencing data bases or websites and/or deriving formulas required for computation of the data values. Thus, an intelligent analytical interface is automatically generated, either alone or alongside other spreadsheet software, allowing the user to obtain data values within the interface by simply altering headers within the interface. The term “intelligent interface” is used herein to reference that fact that the present invention does not require user input of data and/or formulas other than identifying information to populate the data values within the interface, and the interface is able to obtain such data values on its own.

Various exemplary embodiments of the present invention involve retrieving data from one or multiple databases or websites, including data supplied interactively by users of this invention, based on names or labels entered by said users, and preserving the context and derivation of each data value. As discussed above, in an embodiment of the invention, these labels could be headers in a spreadsheet to enable a structured organization of the data. However the method is applicable and valuable for any automated system for retrieving data, with information about the source, purpose and frames of reference, e.g. scale of the data, permitting the data to be easily organized for reporting and analysis. Moreover, because the system maintains the context and source of data values, it is possible to logically and repeatedly perform computations upon the data values without losing data integrity, including but not limited to aggregation, dis-aggregation and filtering.

Further, exemplary processes and systems according to the present invention apply to both numeric and non-numeric data. For example, users may define lists or other aggregations based on textual data such as the names of employees in a department or brands of a consumer product being analyzed. Similarly, collections of multimedia objects such as images, whole documents, and their attributes may be organized and queried using the inventive method and system.

In various exemplary embodiments of the present invention, the method may be implemented using a computer program executed on a computer processor. The computer program may work along side known software that generates the underlying electronic document, or the computer program may be part of software that generates the underlying electronic document. For example the computer program may work alongside spreadsheet software, such as, for example, Excel, by Microsoft Corporation of Redmond, Wash. The program may also work in association with other forms of software in which data can be identified and populated based on identifying information.

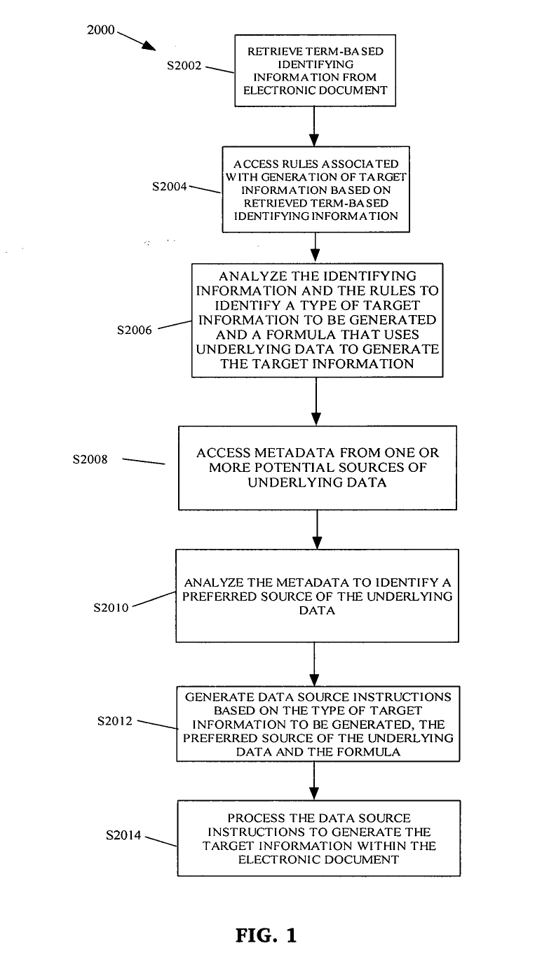

FIG. 1 is a flowchart showing a method, generally designated by reference number 2000, of generating target information within an electronic document according to an exemplary embodiment of the invention. In step S2002 of the method 2000, term-based identifying information is retrieved from the underlying electronic document. For example, if the underlying electronic document is a webpage, key terms of a query statement within the webpage may be retrieved in step S2002 to identify the target information to be generated. From the step S2002, the method 2000 proceeds to step S2004, where rules associated with generation of target information based on the retrieved identifying information are accessed. In this step, one or more databases may be accessed that include rules associated with the identifying information, where the rules may include an equation, a data condition, format instructions, scaling instructions, unit measure of conversions and synonym rules.

In step S2006, the identifying information and the accessed rules are analyzed to identify the type of target information to be generated and to derive a formula that uses underlying data to generate the target information. For example, based on the analysis performed in step S2006, it may be determined that the type of information to be generated is, for example, text, graphics, a numerical value based on a particular level of aggregation or a numerical value given in a particular unit of dimension. When a term is defined by one or more sub-terms, degree of aggregation refers to the sub-term level at which the term is calculated. For example, the term “No. of Cars” may include sub-terms “No. of Cars of Type A”, “No. of Cars of Type B” and “No. of Cars of Type C”, in which case the term “No. of Cars” would be at a higher level of aggregation then the sub-terms “No. of Cars of Type A”, “No. of Cars of Type B” and “No. of Cars of Type C”. The underlying data used in the formula may be, for example, values that are input to an equation or query used to generate the target information.

In step S2008, metadata from one or more potential sources of the underlying data is accessed. The metadata may include descriptions of potential sources of underlying data, such as, for example, databases, websites on the Internet, and other electronic documents located on a local area network (LAN) or a wide area network (WAN). In the case of a database, the metadata may include a database schema, which may include information regarding the conceptual, logical and physical structure of the database.

In step S2010, the accessed metadata is analyzed to identify a preferred source of the underlying data. In this regard, the one or more potential sources may be prioritized based on likelihood of providing appropriate underlying data based on metadata of the potential sources. For example, prioritization may be based on whether data in the potential sources of underlying data is at a level of aggregation that matches that required by the target information, or whether the underlying data can be aggregated to obtain the required level of aggregation.

In step S2012, the data source instructions are generated based on the type of target information to be generated, the preferred source of the underlying data and the formula. It should be appreciated that the step of identifying a preferred source of underlying data is not necessary in this embodiment, as the underlying data may be available from a single or a plurality of pre-set data sources, so that the data source instructions need not be based on the preferred source of underlying data. The data source instructions may be generated in the form of a source array that specifies the formula for determining the target information and the source of data to be input to the formula, as well as the type of target information to be output from the source array. The formula may be in the form of a query and the preferred source may be a database that supplies appropriate data (e.g., at the appropriate level of aggregation) in response to the query. Alternatively, the formula may be an equation for calculating the target information, and the preferred source may be a database that supplies underlying data to the equation.

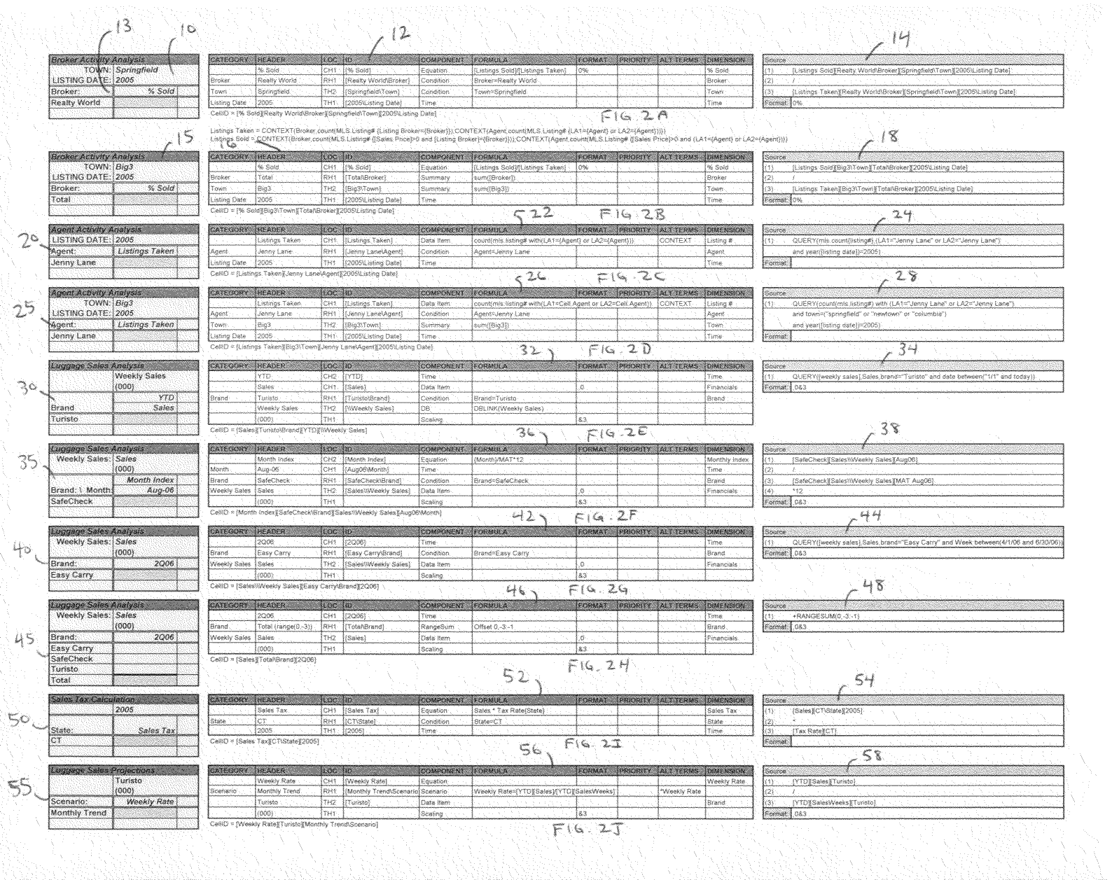

Exemplary methods according to the present invention will be described herein with reference to various spreadsheet examples, such as spreadsheets related to sales activity. In this regard, reference to FIGS. 2A-J are made throughout the following description, which show portions of sales spreadsheets (spreadsheets 10-55, respectively), with corresponding cell header tables (cell header table 12-56, respectively) for a particular cell in each spreadsheet and corresponding outputs as data value sources (sources 14-58, respectively). However, it should be appreciated that reference to sales activity spreadsheets is made merely for explanatory reasons, and such reference should not be interpreted to indicate that the present invention is limited to use with sales spreadsheets. On the contrary, the present invention may be used to obtain data values pertaining to any type of information requested based on user input of headers or other identifying information within a particular spreadsheet.

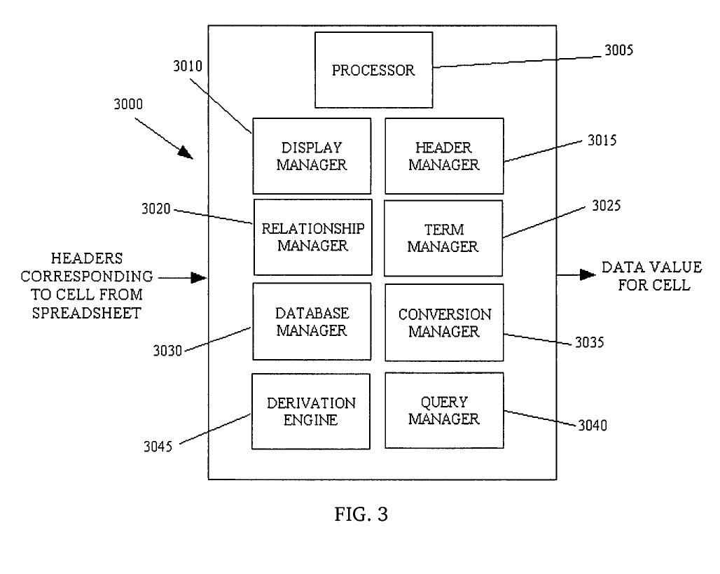

Throughout the following description, reference will also be made to FIG. 3, which is a block diagram showing a system, generally designated by reference number 3000, for generating target information within an electronic document based on identifying information contained within the electronic document. In general, the system 3000 includes a processor 3005, a display manager 3010, a header manager 3015, a relationship manager 3020, a term manager 3025, a database manager 3030, a conversion manager 3035, a query manager 3040 and a derivation engine 3045. The display manager 3010 places a formula or data value in an electronic document. The various functions of the display manager 3010 and the other components of the system 3000 will be explained in further detail below. It should be appreciated that these components may be, for example, program objects that form portions of a computer readable program for executing the methods according to various exemplary embodiments of the present invention on the processor 3005. Alternatively, one or more of the various components of the system 3000 may be separate hardware components. It should also be appreciated that these components are merely exemplary, and the system 3000 may include any number and combination of components to perform the methods according to the various exemplary embodiments of the present invention.

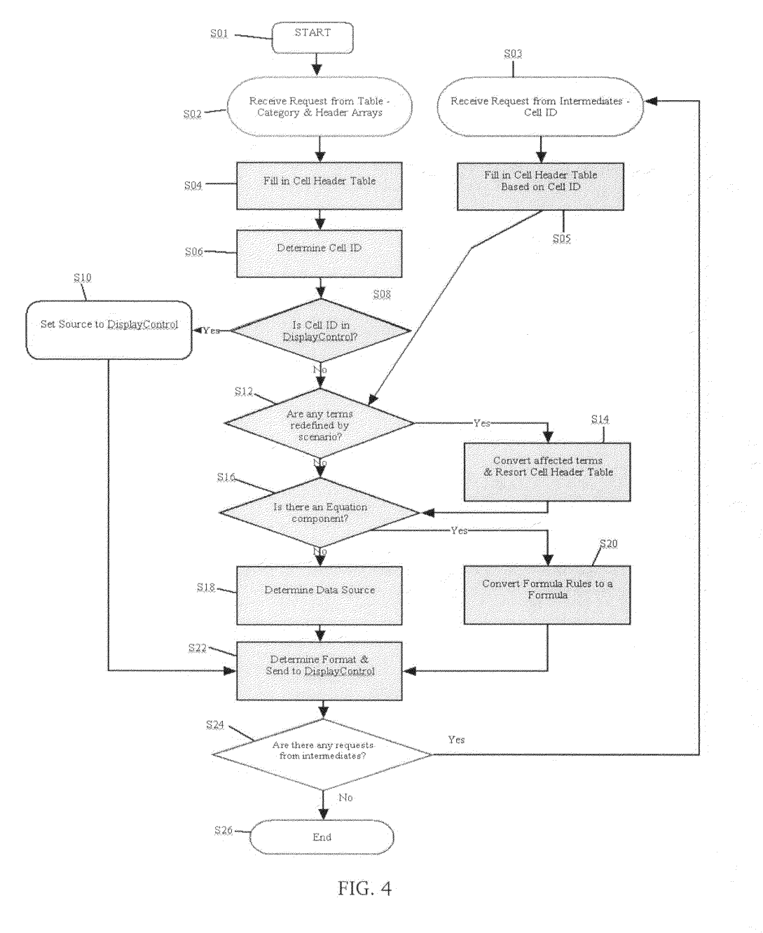

FIG. 4 is a flowchart showing a method, generally designated by reference number 1, of generating target information (i.e., cell data) within a spreadsheet according to target information (i.e., cell header information) contained within the spreadsheet. Referring now to FIG. 4, the process 1 starts at step S01 and in step S02 a request is made for a data value corresponding to a cell of the underlying spreadsheet by referencing categories, row headers and column headers that define the cell within the spreadsheet. As explained in further detail below, the process 1 results in the generation of a source, identified herein as a “source array”, for obtaining the necessary data to be input to the cell. The source array may contain information regarding a particular database from which the necessary data may be obtained and/or elements of a formula that is used to calculate the data. Alternatively, the process 1 may begin at step S03, where a request is made for a data value corresponding to intermediate elements (herein referred to as “intermediates”) of a source array used to obtain a data value for a particular cell in the underlying spreadsheet. The term “intermediates” is used herein because these terms have been previously determined to be elements of a source array, but elements of these terms may need to be reduced to recognizable data sources or formulas which can be used to generate the target information. Thus, the intermediate elements are processed through another iteration of the method 1. Each intermediate may be associated with a cell ID, as explained in further detail below.

The display manager 3010 identifies which entries in a spreadsheet are categories and which entries are headers. Both a category and a header may be used to identify the data value to be entered into the cell. “Category” refers to a generic descriptive term, while “header” refers to a more specific descriptive term that may or may not be within a “category”. For example, the categories in spreadsheet 10 of FIG. 2A are “Broker”, “Town” and “Listing Date”, and the headers are “% Sold”, “Realty World”, “Springfield” and “2005”. It should be noted that not every header necessarily belongs to a category. For example, “% Sold” in the spreadsheet 10 is not an entry under a category.

A category is specific to a header. A category is located within a spreadsheet immediately above a column of row headers or immediately to the left of a row of column headers. The display manager 3010 identifies the categories and headers in a spreadsheet by using a set of rules. For example, the display manager may reference the location at which two double lines cross within the spreadsheet to determine the location of the categories and headers within the spreadsheet. For example, in the spreadsheet 10, the double lines cross at a point 13, and the cells on the upper left in relation to the point 13 are identified as categories, the cells on the lower left in relation to the point 13 are identified as row headers, the cells on the upper right in relation to the point 13 are identified as column headers, and the cells on the lower right in relation to the point 13 are identified as empty cells in which data values are to be entered. Other positioning rules may apply in other exemplary embodiments of the present invention.

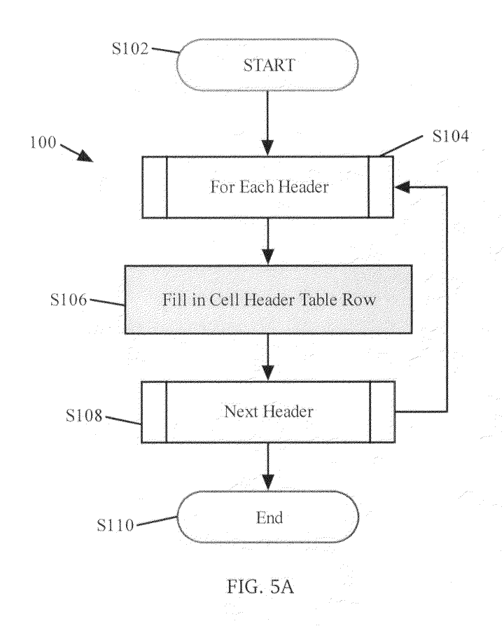

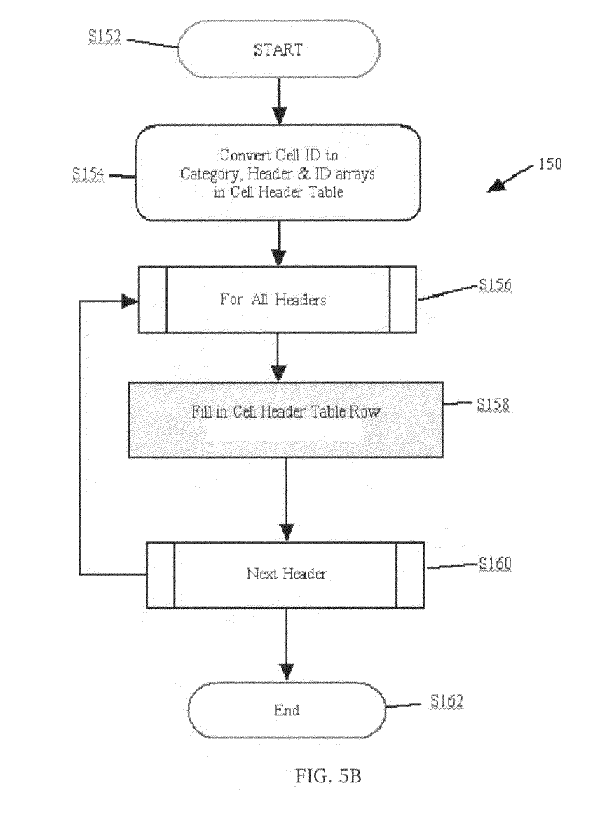

In step S04, a cell header table is generated for the cell. The term “cell header table” as used herein refers to a table which includes the various headers and categories, along with other attributes, which define the cell in which data is to be generated. For example, the cell header table 12 of FIG. 2A includes columns labeled “CATEGORY”, “HEADER”, “ID”, “COMPONENT”, “FORMULA”, “FORMAT”, “PRIORITY”, “ALT TERMS”, “DIMENSION” and “LOC”. The “CATEGORY” column in the cell header table lists all of the categories corresponding to a particular cell in a spreadsheet. For example, the “CATEGORY” column in the cell header table 12 lists the categories “Broker”, “Town” and “Listing Date” from the spreadsheet 10. The “HEADER” column in the cell header table lists all of the headers corresponding to a particular cell in a spreadsheet, with each header paired up with a corresponding category, if a corresponding category exists. For example, the “HEADER” column in the cell header table 12 lists the headers “% Sold”, “Realty World”, “Springfield” and “2005”, with the header “% Sold” having no corresponding category. The other columns of the cell header table will be further defined throughout the following description. In general, step S04 results in the generation of information and rules related to each header, where the information includes, for example, a formula associated with the header, the desired format in which values under the header are displayed, the priority of the header in relation to other headers that define the cell, terms that may be used as an alternative to the header term and the dimension of the header. FIG. 5A is a flowchart showing a method, generally designated by reference number 100, of filling in a cell header table according to an exemplary embodiment of the present invention. The process 100 for filling in a cell header table will be explained in further detail below.

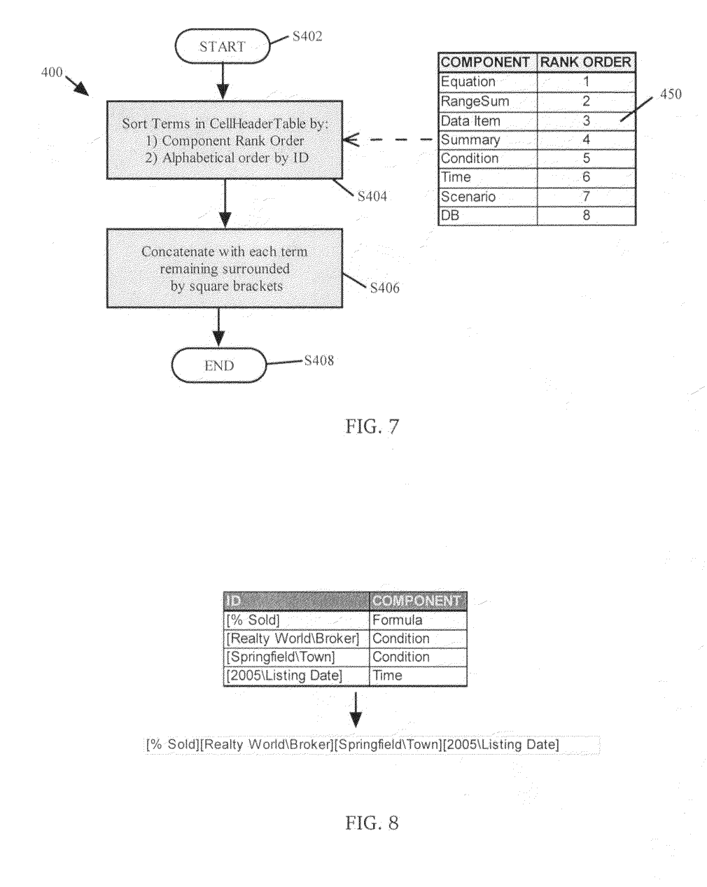

From step S04, the process 1 continues to step S06, where the cell ID for the cell under evaluation is determined. Determination of the cell ID is useful in that the value to be input to other cells having the same cell ID can be easily obtained by referencing the already calculated value that corresponds to that cell ID. In this regard, cell IDs and their corresponding cell values may be stored in the display manager 3010. FIG. 7 is a flowchart showing a process, generally designated by reference number 400, for determining a cell ID. The process 400 for determining the cell ID will be explained in further detail below.

Alternatively, in step S05, a cell header table is filled in based on the cell ID of an intermediate. FIG. 5B is a flowchart showing a process, generally designated by reference number 150, of filling in a cell header table according to an exemplary embodiment of the present invention when a request is made for a data value corresponding to intermediate elements of a source array used to obtain a data value for a particular cell in the underlying spreadsheet.

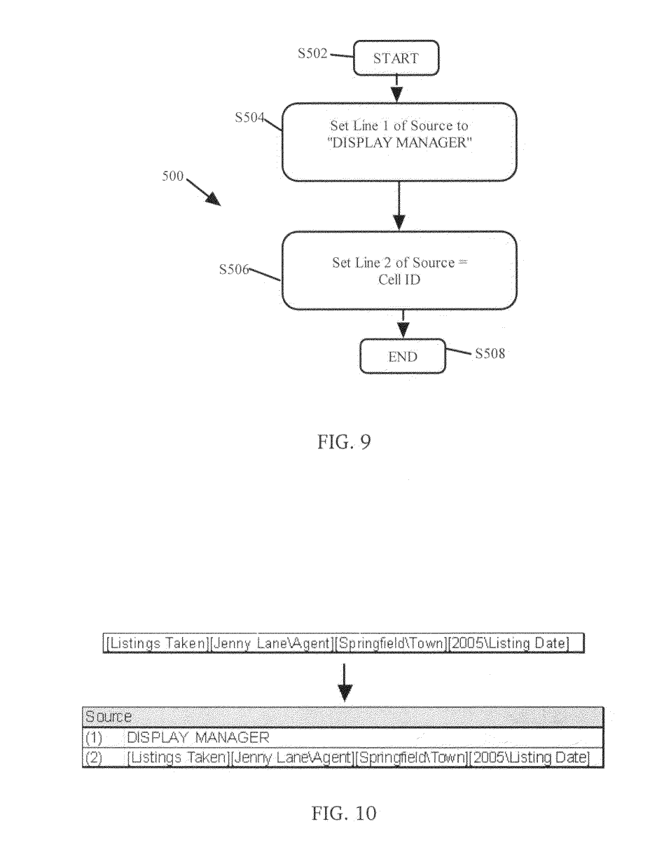

From step S06, the process 1 continues to step S08, where it is determined whether the cell ID is one that corresponds to a cell ID already stored in the display manager 3010. If so, the process 1 proceeds to step S10, where the source is set to the display manager 3010, meaning that the source is instructed to refer to stored cell ID in the display manager 3010 to determine the value for the cell under evaluation. FIG. 9 is a flowchart showing a process, generally designated by reference number 500, for setting the source to display manager 3010 according to an exemplary embodiment of the present invention. The process 500 will be explained in further detail below.

If it is determined in step S08 that the cell ID is not in the display manager 3010, or after a cell header table is filled in based on the cell ID corresponding to an intermediate in step S03, the process 1 continues to step S12, where it is determined whether any terms in the cell header table are redefined by a scenario. The term “scenario” refers to a situation in which a term is defined differently depending on a prediction scenario. For example, in cell header table 56, the projected “Weekly Rate” of sales is defined by “Monthly Trend”, but may also be defined by annual trend as a different scenario, in which case an alternative formula would be used to calculate “Weekly Rate”.

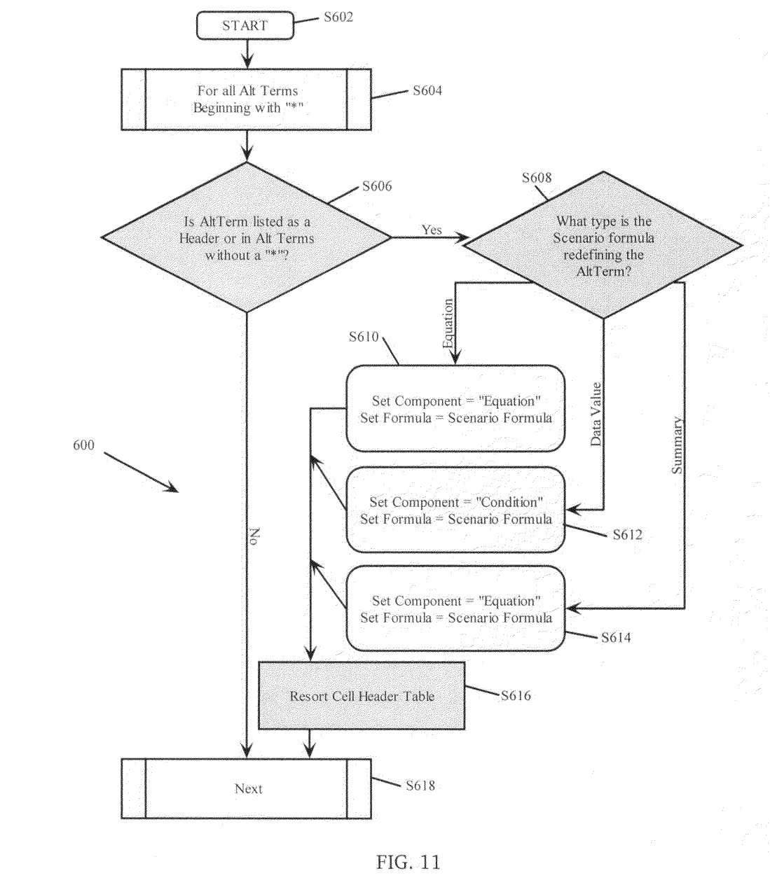

If it is determined in step S12 that one or more terms are redefined by a scenario, the process continues to step S14, where the affected terms are converted and the cell header table is resorted. FIG. 11 is a flowchart showing a process, generally designated by reference number 600, for converting scenario terms and resorting the cell header table according to an exemplary embodiment of the present invention. The process 600 is explained in further detail below.

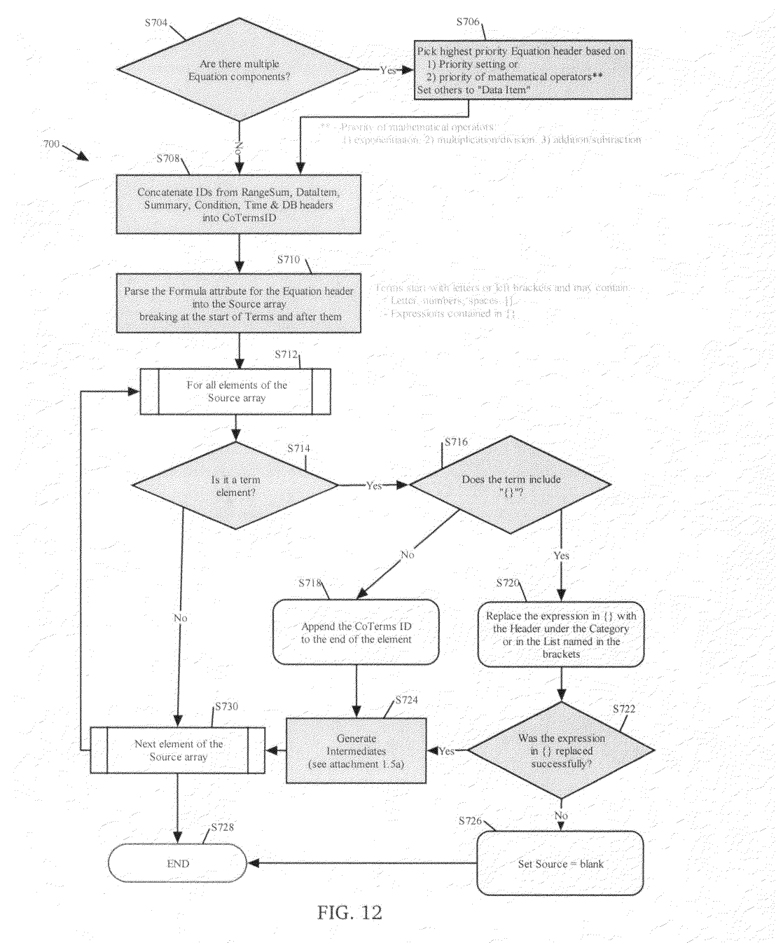

From step S14, or after it is determined in step S12 that there are no terms that are redefined by a scenario, the process 1 continues to step S16, where it is determined whether any of the headers have a corresponding component in the cell header table that is set equal to “Equation”. If so, a formula must be determined that corresponds to the header. Thus, the process 1 continues to step S20, where formula rules are used to determine a formula. The term “formula rule” as used herein refers to an abstraction of a formula which describes a general calculation to be performed, with variables referencing specific data to be evaluated during execution of an actual cell calculation. For example, a formula rule might describe a general sales tax calculation as “Sales Tax=0.06*Sales”, where the variable “Sales” would need to be evaluated. FIG. 12 is a flowchart showing a process, generally designated by reference number 700, for converting formula rules to a formula according to an exemplary embodiment of the invention. Process 700 will be explained in further detail below.

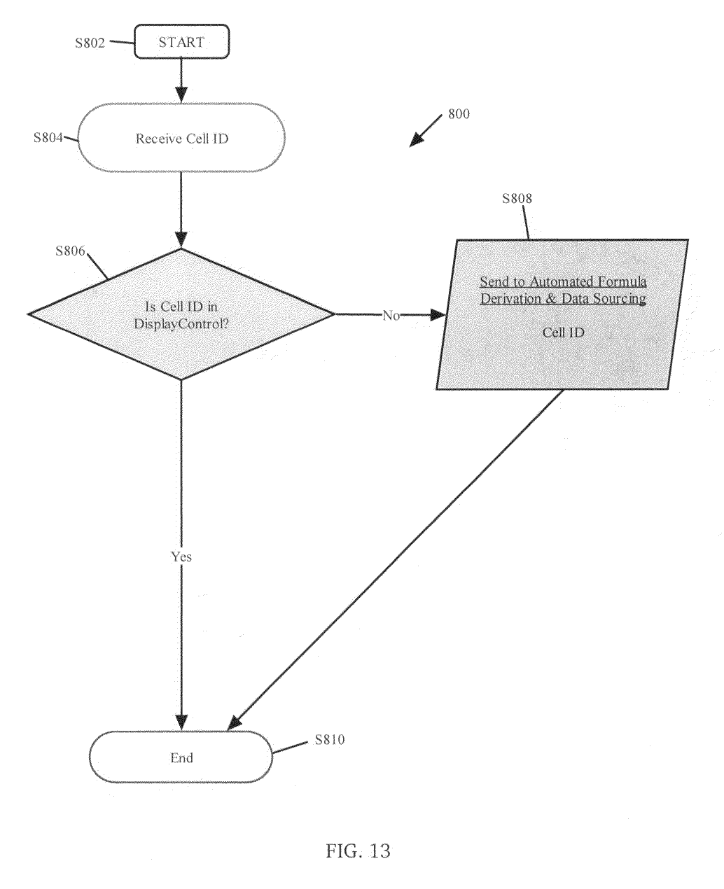

If it is determined in step S16 that none of the headers have a corresponding component in the cell header table that is set equal to “Equation”, this indicates that the value for the cell is not determined by a formula, but is instead obtained by referencing a data source, such as a database. In this regard, if a formula is not applicable, a query must be generated that references an appropriate data source. It should be appreciated that, for the purposes of the present disclosure, the query may also be considered a “formula”. Thus, from step S16, the process continues to step S18, where the data source is determined. FIG. 13 is a flowchart showing a process, generally designated by reference number 900, for determining a data source according to an exemplary embodiment of the present invention. The process 900 will be explained in further detail below.

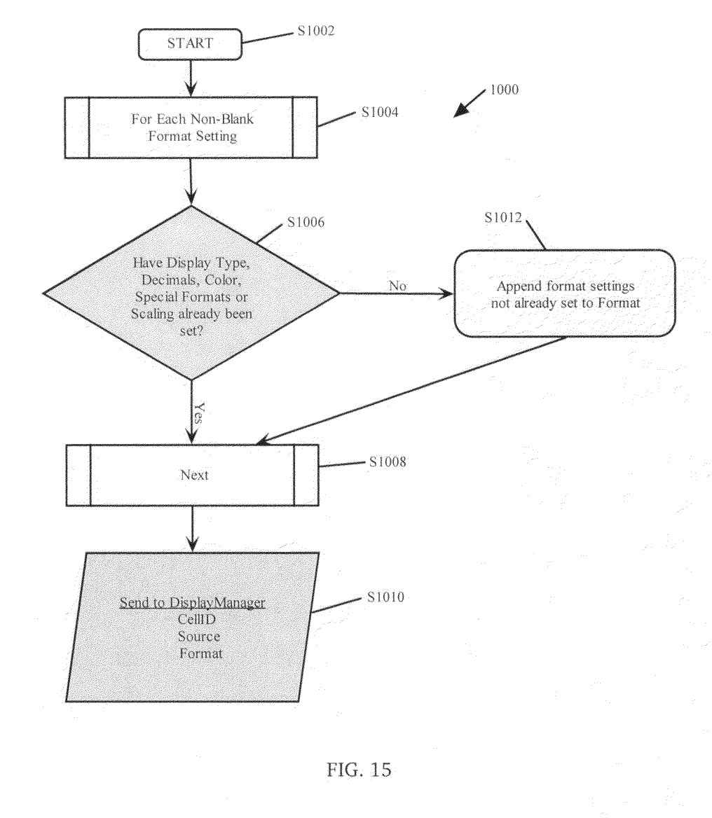

After the data source is determined in step S18, the formula is generated in step S20 or the source is set to the display manager 3010 in step S10, the process 1 continues to step S22, where the format for the data value to be input to the cell is determined and sent to the display manager 3010. FIG. 15 is a flowchart showing a process, generally designated by reference number 1000, for determining format and sending to display manager according to an exemplary embodiment of the present invention. The process 1000 will be explained in further detail below.

From step S22, the process 1 continues to step S24, where it is determined whether any intermediate elements of the formula generated in step S20 or the query generated in step S18 do not result in appropriate target information to be input to the cell. For example, it may be determined that a term in the generated formula may need to be calculated before the formula can be processed. If so, the method 1 jumps back to step S03, where a request from intermediates is received.

Upon completion of the steps in the process 1, all the information required to input the appropriate data into the cell being evaluated, including the data source and/or the formula used to calculate the cell value, as well as the format in which the data is to be displayed, is obtained. This information may be sent to the display manager 3010, where the necessary data is calculated using the generated formula or retrieved from the appropriate data source to populate the cell under evaluation. The process 1 then ends at step S26.

FIG. 5A is a flowchart showing the process 100 of filling in a cell header table according to an exemplary embodiment of the present invention when a request is made for a data value corresponding to a cell of the underlying spreadsheet by referencing a category, row header and column header that define the cell. In step S102, the process 100 starts, and a header is selected at step S104. The process 100 then continues to step S106, where the cell header table row for that header is filled in. The process 100 then continues to step S108, where another header is selected and the process 100 iterates until all the rows in the cell header table are filled. The process 100 then ends at step S10.

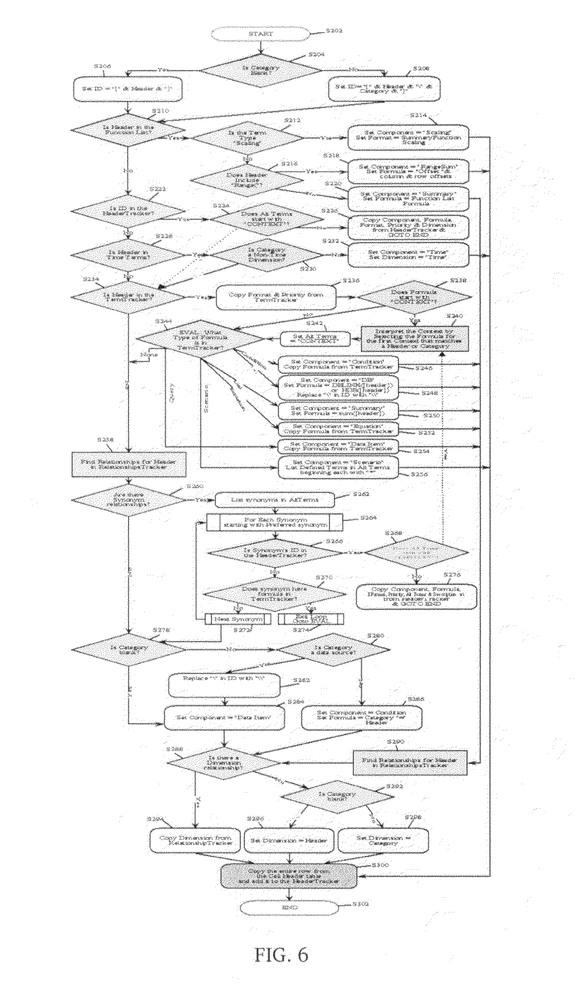

FIG. 6 is a flowchart showing a process, generally designated by reference number 200, for filling in a row of a cell header table according to an exemplary embodiment of the present invention. Each row may include a “category” attribute, a “header” attribute, an “ID” attribute, a “component type” attribute, a “formula” attribute, a “format” attribute, a “priority” attribute, an “alt terms” attribute, a “dimension” attribute and a “LOC” attribute. The process 200 begins at step S202, and at the next step S204, it is determined whether the “category” attribute of the row is blank. If the “category” attribute is blank, the process 200 continues to step S206, where the “ID” attribute of the row is set equal to “[HEADER]”. Otherwise, in step S208, the “ID” attribute is set equal to “[HEADER\CATEGORY]”. For example, as shown in the first row of cell header table 10, the “ID” attribute is set equal to “[% Sold]”, since the “category” attribute of that row is blank, while in the second row, the “ID” attribute is set equal to “[Realty World\Broker]”, since there is a “category” attribute in that row.

From both steps S206 and S208, the process 200 continues to step S210, where it is determined whether the “header” attribute is in a list of “header” attributes that are predefined to correspond to a particular function. For example, a particular “header” attribute may be predefined to correspond to a computational function (e.g., “total” or “average”) or a scaling function (e.g., (000), $B). If so, then the process 200 continues to step S212, where it is determined whether the “header” attribute corresponds to a scaling function. If the “header” attribute does correspond to a scaling function, then the process 200 continues to step S214, where the “component” attribute is set equal to “scaling”, and the “format” attribute is set equal to a scaling code found in the summary function table. For example, the “header” attribute in the last row of cell header table 36 refers to the scaling function “(000)”, and thus the “component” attribute in that row is set equal to “scaling” and the “format” attribute in that row is set equal to “&3”. From step S214, the process jumps to step S300, where the entire row from the cell header table is copied and added to the header manager 3015. The header manager 3015 tracks each header/category combination that is entered by the user and its associated attributes within a cell header table.

In step S212, if it is determined that the “header” attribute does not correspond to a scaling function, then the process 200 continues to step S216, where it is determined whether the “header” attribute includes the term “range”. If so, the process 200 continues to step S218, where the “component” attribute is set equal to “RangeSum”, and the “formula” attribute is set equal to “Offset, column offset, row offset”. In step S218, a range of cells from the spreadsheet on top of which the process 200 is working is set for summation. For example, the “header” attribute in the second row of cell header table 46 includes the term “range(0,−3)”, and thus the “component” attribute of that row is set equal to “RangeSum” and the “formula” attribute in that row is set equal to “Offset 0, −3: −1”, meaning that the data to be summed for the cell is obtained with no column offset and a row offset starting from three above the cell to one above the cell. From step S218, the process 200 jumps to step S300, where the entire row from the cell header table is copied and added to the header manager 3015.

In step S216, if the “header” attribute does not include the term “range”, the process continues to step S220, where the “component” attribute is set equal to “Summary” and the “formula” attribute is set equal to a function list formula, meaning that the data for the cell will be calculated using an appropriate summing formula. For example, the “header” attribute in the second row of cell header table 16 does not include the term “range” and does not correspond to a scaling function, and thus the “component” attribute is set equal to “Summary” and the “formula” attribute is set equal to “sum([Broker])”. In this case, the “formula” attribute is not set equal to “sum([Total])”, because the term “Total” is recognized as referring to a particular function from a predefined function list. From step S220, the process 200 jumps to step S290, where the relationships for the “header” attribute is found in the relationship manager 3020, as explained in further detail below. The relationship manager 3020 stores a predefined set of terms which are related to a term that defines a particular “header” attribute.

In step S210, if the “header” attribute does not correspond to a function, the process 200 continues to step S222, where it is determined whether the “ID” attribute has been previously tracked. In various exemplary embodiments of the present invention, “ID” attributes may be tracked using the header manager 3015. If the “ID” attribute is in the header manager 3015, then the attributes of the row can be copied from a previously tracked row that has the same “ID” attribute. However, the process first goes to step S224, where it is determined whether the “alt terms” attribute of the tracked row starts with the term “CONTEXT”, meaning that the formula for calculating the data in the cell varies depending on the context in which it is used. In this regard, “alt terms” refers to terms that redefine other terms within the cell header table, and may include, for example, context, synonym and scenario. If the “alt terms” attribute of the tracked row does not start with the term “CONTEXT”, the process 200 continues to step S226, where the attributes of the tracked row are copied into the cell header table, and the process ends. Otherwise, the process jumps to step S234, where it is determined whether the “header” attribute matches a term that has been previously tracked by the term manager 3025. In this regard, the term manager 3025 includes a list of terms which have been previously tracked by the system 3000. Step S234 and the subsequent steps are discussed in further detail below.

In step S222, if it is determined that the “ID” attribute has not been previously tracked, the process 200 continues to step S228, where it is determined whether the “header” attribute matches any one of predefined terms or formats (e.g., “any four digit number beginning with 20??”) related to time. Such time terms may be, for example, a particular year, a particular date, a particular quarter or “YTD”. If the “header” attribute is a time term, the process continues to step S230, where it is determined whether the “category” attribute includes a non-time dimension. If so, the “header” attribute is not referring to time, even if the “header” attribute matches a time term. If it is determined that the “header” attribute is not a time term in step S228, or if it is determined that the “category” attribute includes a non-time dimension in step S230, then the process 200 continues to step S234. Otherwise, the process 200 continues to step S232, where the “component” and “dimension” attributes are set equal to “Time”, and then jumps to step S300, where the entire row from the cell header table is copied and added to the header manager 3015. In step S222, if it is determined that the “ID” attribute has not been previously tracked, the process 200 continues to step S234, where it is determined whether the “header” attribute matches a term that has been previously tracked by the term manager 3025.

As explained above, from either steps S224, S228 or S230, the process 200 may continue to step S234, where it is determined whether the “header” attribute matches a term that has been previously tracked by the term manager 3025. If it is determined in step S234 that the “header” attribute matches a previously tracked term, then the process 200 continues to step S236, where the corresponding “format” and “priority” attributes are copied from the term manager 3025. The process 200 then continues to step S238, where it is determined whether the “formula” attribute of the tracked term begins with the term “CONTEXT”, meaning that the term (“format” or “formula” attribute) can have different meanings depending on the other headers and categories that are defining the same cell. If so, then the process 200 continues to step S240, where the context is interpreted to determine the correct formula to use. The context may be interpreted by reviewing the “category” and “header” attributes of the cell header table. For example, in cell header table 12, “Broker” is defined as one of the “category” components, so that the correct formula for “Listings Taken” would be the one that calculates listings taken by a broker. After the context is interpreted in step S240, the process 200 continues to step S242, where the “alt terms” component of the cell header table is set equal to the term “CONTEXT”, so that, when step S234 is performed in subsequent iterations, the algorithm will know to re-evaluate the context.

If it is determined that the “formula” attribute does not begin with the term “CONTEXT” in step S238, or after the “alt terms” is set equal to “CONTEXT” in step S242, the process 200 continues to step S244, where the type of formula that defines the “formula” attribute of the tracked term is determined. For example, the “formula” attribute may be an equation, a reference to a database, a reference to a list, a condition, a scenario or a query. If the corresponding “formula” attribute is a condition, the process 200 continues to step S246, where the “component” attribute is set equal to “Condition” and the formula is copied from the term manager 3025. If the corresponding “formula” attribute is a reference to a database, then the process 200 continues to step S248, where the “component” attribute is set equal to “DB”, the “formula” attribute is set to reference a specific database, such as, for example, an external database or an internal database, and “\” in the “ID” component is replaced with “\\”. If the corresponding “formula” attribute is a list, the process 200 continues to step S250, where the “component” attribute is set equal to “summary” and the “formula” attribute is set equal to “sum([header])”. For example, in the third row of the cell header table 16, the “formula” component is a list which references the corresponding “header” component, “Big3”. If the corresponding “formula” attribute is an equation, the process 200 continues to step S252, where the “component” attribute is set equal to “Equation” and the formula is copied from the term manager 3025. If the corresponding “formula” attribute is a query, the process 200 continues to step S254, where the “component” attribute is set equal to “Data Item” and the formula is copied from the term manager 3025. The “formula” attribute may also correspond to a scenario, meaning that one or more terms within the formula may be defined differently depending on a prediction scenario. This is shown in cell header table 56, which shows the projected “Weekly Rate” of sales defined by “Monthly Trend”. This means that in this particular example the monthly trend is used to predict a weekly rate, but annual trend may also be used. If the “formula” attribute corresponds to a scenario, the process 200 continues to step S256, where the “component” attribute is set equal to “Scenario” and the “alt terms” attribute includes a list of the defined terms each beginning with “*”. From steps S246, S248, S250, S252 and S254, the process 200 jumps to step S290, where the relationships for the “header” attribute is found in the relationship manager 3020. From step S256, the process 200 jumps to step S300, where the entire row from the cell header table is copied and added to the header manager 3015.

If it is determined that the “header” attribute does not match a term that has been previously tracked by the term manager 3025 in step S234 or that the term manager 3025 did not track any formula in step S244, the process 200 continues to step S258, where relationships between the term that defines the “header” attribute and another term are sought from the relationship manager 3020. The process 200 then continues to step S260, where it is determined whether any relationships involving the term that defines the “header” attribute are synonym relationships. If so, the process 200 continues to step S262, where the synonyms are listed in the “alt terms” attribute. From step S262, the process 200 continues to step S264, where a synonym from the list of synonyms is selected, starting with a predefined preferred synonym. In step S266, it is determined whether an “ID” attribute associated with the selected synonym is in the header manager 3015. If so, the process 200 continues to step S268, where it is determined whether the “alt terms” attribute for the synonym starts with the term “CONTEXT”. If so, then the process 200 jumps back to step S240, where the context is interpreted to determine the correct formula. Otherwise, the process 200 continues to step S276, where the entire row from the cell header table is copied and added to the header manager 3015 and the process ends.

In step S266, if it is determined that the “ID” attribute of the synonym is not in the header manager 3015, the process 200 continues to step S270, where it is determined whether the synonym has a corresponding “formula” attribute in the term manager 3025. If so, the particular synonym is selected, and in step S274 the process 200 jumps back to step S244, where the type of formula in the “formula” attribute is determined. Otherwise, the process 200 continues to step S272, where the next synonym from the list is selected to determine whether the synonym's “ID” attribute is in the header manager 3015 (step S266) or the synonym's “formula” attribute is in the term manager 3025 (step S270).

After all the synonyms relating to the “header” attribute have been evaluated and no appropriate synonym has been found, or if it is determined that there is no synonym relationship between the term that defines the “header” attribute and another term in step S260, the process 200 continues to step S278, where it is determined whether the “category” attribute is blank. If so, the process 200 continues to step S284, where the “component” attribute is set equal to “Data Item”. If it is determined in step S278 that the “category” attribute is not blank, the process 200 continues to step S280, where it is determined whether the “category” attribute refers to a data source, such as a database. If so, the process 200 continues to step S282, where “\\” is used in the “ID” attribute and the “formula” attribute is set to reference a particular internal or external database. The process 200 then continues to step S284, where the “component” attribute is set equal to “Data Item”.

If it is determined in step S280 that the “category” attribute is not a data source, the process 200 continues to step S286, where the “component” attribute is set equal to “Condition” and the “formula” attribute is set equal to “[Category]=[Header]”. This indicates that the value to be determined for the cell should be calculated with the condition that one of the variables in the formula is set at a constant. For example, in cell header table 12, the formula used to calculate the value for the cell is used with the condition that “Broker=Realty World”.

From either steps S284, S286 or S290, the process 200 continues to step S288, where it is determined whether a dimension relationship exists between the “header” attribute and a term, as defined in the relationship manager 3020. If a dimension relationship exists, the process 200 continues to step S294, where the “dimension” attribute is copied from the relationship manager 3020. Otherwise, the process 200 continues to step S292, where it is determined whether the “category” attribute is blank. If the “category” attribute is blank, the process 200 continues to step S296, where the “dimension” attribute is set equal to the “header” attribute. If the “category” attribute is not blank, the process 200 continues to step S298, where the “dimension” attribute is set equal to the “category” attribute. From steps S294, S296 or S298, the process 200 continues to step S300, where the entire row from the cell header table is copied and added to the header tracker 3015. The process 200 then ends at step S302.

FIG. 5B is a flowchart showing the process 150 of filling in a cell header table according to an exemplary embodiment of the present invention when a request is made for a data value corresponding to intermediate elements of a source array used to obtain a data value for a particular cell in the underlying spreadsheet. The process 150 starts at step S152, and proceeds to step S154, where the cell ID for the intermediate is converted to category, header and ID arrays in a cell header table. The process 150 then continues to step S156, where a “header” attribute in the cell header table is selected, and the cell header table row for the “header” attribute is filled in at step S158. The process 150 then continues to step S160, where the next “header” attribute is selected, and the process 150 iterates through steps S156-S160 until all the rows in the cell header table are filled. The process 150 then ends in step S162.

FIG. 7 is a flowchart showing the process 400 for determining the cell ID. In step S402, the process 400 starts and continues to step S404 where the terms in the cell header table are sorted first by component rank order and then by alphabetical order. Table 450 in FIG. 6 shows the rank of components, with “Equation” being ranked first and “DB” being ranked last. The process then continues to step S406, where the cell ID is determined by concatenating each of the “ID” components corresponding to each of the “component” attributes, with each “ID” component remaining surrounded by square brackets. For example, as shown in FIG. 8, the cell ID for cell header table 12 is [% Sold] [Realty World\Broker] [Springfield\Town] [2005\Listing Date]. Although both [Realty World\Broker] [Springfield\Town] are condition terms, and thus are ranked the same, [Realty World\Broker] is listed first based on alphabetical priority. The process 400 then ends at step S408.

FIG. 9 is a flowchart showing the process 500 for setting the source to the display manager 3010 according to an exemplary embodiment of the present invention. In step S502 of the process 500, the method starts and proceeds to step S504, where line 1 of the source is set to “DISPLAY MANAGE”. The process 500 then proceeds to step S506, where line 2 of the source is set to the cell ID. For example, as shown in FIG. 10, the cell ID as determined in FIG. 7 is set to the display manager, so that line 1 is set to “DISPLAY MANAGER” and line 2 is set to [% Sold] [Realty World\Broker] [Springfield\Town] [2005\Listing Date]. The process 500 then ends at step S508.

FIG. 11 is a flowchart showing the process 600 for converting scenario terms and resorting the cell header according to an exemplary embodiment of the present invention. In step S602, the process 600 starts and continues to step S604, where an “alt term” attribute that begins with “*” selected and, in step S606, it is determined whether the “alt term” attribute is also listed as a “header” attribute or is listed as an “alt term” attribute without an “*” (meaning that the alt term is referring to a synonym). If so, the process 600 continues to step S608, where it is determined what type of formula the scenario is using to redefine the “alt term” attribute. For example, the formula may be an equation, a data value or a summary. If the formula is an equation, the process continues to step S610, where the “component” attribute is set equal to “Equation” and the “formula” attribute is set equal to “Scenario Formula”. If the formula is a data value, the process continues to step S612, where the “component” attribute is set equal to “Condition” and the “formula” attribute is set equal to “Scenario Formula”. If the formula is a summary, the process continues to step S614, where the “component” attribute is set equal to “Equation” and the “formula” attribute is set equal to “Scenario Formula”. The process 600 then continues to step S616, where the cell header table is resorted, as in process 400 shown in FIG. 7. The process 600 then continues to step S618, where the next “alt term” attribute that begins with “*” is selected, and the process 600 returns to step S606.

FIG. 12 is a flowchart showing the process 700 for converting formula rules to a formula according to an exemplary embodiment of the present invention. Cell header table 12 and source array 14 will be referenced to shows an example of the process 700 being implemented to convert the attributes of a cell header table into formulas of a source array. In step S702, the process 700 starts and continues to step S704, where it is determined whether there are multiple equation components in the cell header table. If so, the process 700 continues to step S706, where the “header” attribute having the highest priority corresponding “component” attribute that is set equal to “Equation” is selected. The priority may be based on a pre-determined priority setting or priority of mathematical operators (rank 1: exponentiation; rank 2: multiplication/division; rank 3: addition/subtraction). The non-selected “component” attributes that are set equal to “Equation” are reset to equal “Data Item”. In the cell header table 12, there is only one equation component, “[Listings Sold]/[Listings Taken]”.

From steps S704 and S706, the process 700 continues to step S708, where all the “ID” attributes that correspond to “component” attributes which are set equal to “RangeSum”, “Data Item”, “Summary”, “Condition”, “Time” or “DB” are concatenated to form a co-terms ID. Thus, for the cell header table 12, the IDs “[Realty World\Broker]”, “[Springfield\Town]” and “[2005\Listing Date]” are concatenated to form co-terms ID “[Realty World\Broker] [Springfield\Town] [2005\Listing Date]”.

The process 700 then continues to step S710, where the remaining “formula” attribute having a corresponding “component” attribute that is an “equation” is parsed into the source array, by breaking before and after terms within the “formula”. The terms of a source array are recognized using a set of rules. For example, terms may start with letters or left brackets and may contain letters, numbers, or spaces contained in brackets [ ] or expressions contained in brackets { }. For example, in the cell header table 12, the formula attribute “=[Listings Sold]/[Listings Taken]” is parsed into three source array elements: (1) “[Listings Sold]”; (2) “/”; and (3) “[Listings Taken]”, which are then listed in the source array 703. In this example, the operand “/” is not considered a term of the source array 703, even though it is listed as part of the second element of the source array 703.

The process 700 then continues to step 712, where an element of the source array is selected. The process then continues to step S714, where it is determined whether the selected element is a term element. If so, the process continues to step S716, where it is determined whether the term is contained within brackets { }. If the term is contained in brackets { }, the process 700 proceeds to step S720, where the expression in brackets { } is replaced with the header attribute corresponding to the category attribute or list named in the brackets. As an example, cell header table 52 in FIG. 21 shows the formula attribute corresponding to the component attribute, defined as an equation, being represented as “Sales*Tax Rate{State}”. The expression {State} can be handled in two ways: 1) If there is a category in the cell header table called “State”, the corresponding header is substituted for “State”, so that the third element of the source array 64 reads as [Tax Rate][CT]; or 2) if the user has not entered the category “State”, but has defined a list called “State” that has the header (in this case, “CT”) in it, the header found on the list is substitute for “State”, so that the third element of the source array 64 reads as [Tax Rate][CT].

From step S720, the process 700 then continues to step S722, where it is determined whether the expression within the brackets { } was replaced successfully by either the header under the category or in the list named in the brackets { }. If not, the process 700 continues to step S726, where the source is set equal to blank, meaning that the particular source array can not be determined.

In step S716, if it is determined that the term does not include an expression in brackets { }, the process 700 continues to step S718, where the coterms ID which was determined in step S708 is appended to the end of the element. From step S718, or if it determined in step S722 that the expression in brackets { } was successfully replaced, the process 700 proceeds to step S724, where intermediates of the source array are generated. FIG. 13 is a flowchart showing a process, generally designated by reference number 800, for generating intermediates according to an exemplary embodiment of the present invention. The process 800 starts at step S802, and continues to step S804, where either the term element with the coterms appended from step S718 or the term with the expression in brackets { } successfully replaced from step S722 is received as a cell ID. The process 800 then continues to step S806, where it is determined whether the cell ID is in the display manager 3010, which means that that particular cell ID is associated with a known value. If the cell ID is not in the display manager 3010, the cell ID is considered an “intermediate”, and further processing is required before the data can be sourced or formula can be derived. Thus, the process 800 continues to step S808, where the cell ID is places in a queue for intermediates to go through the automated formula derivation and data sourcing of process 1. From either steps S806 or S808, the process 800 proceeds to step S810, where the process 800 ends.

From step S724, the process 700 continues to step S730, where the next element of the source array is selected. Once all elements have been evaluated, or if the source is set equal to blank in step S726, the process 700 ends at step S728.

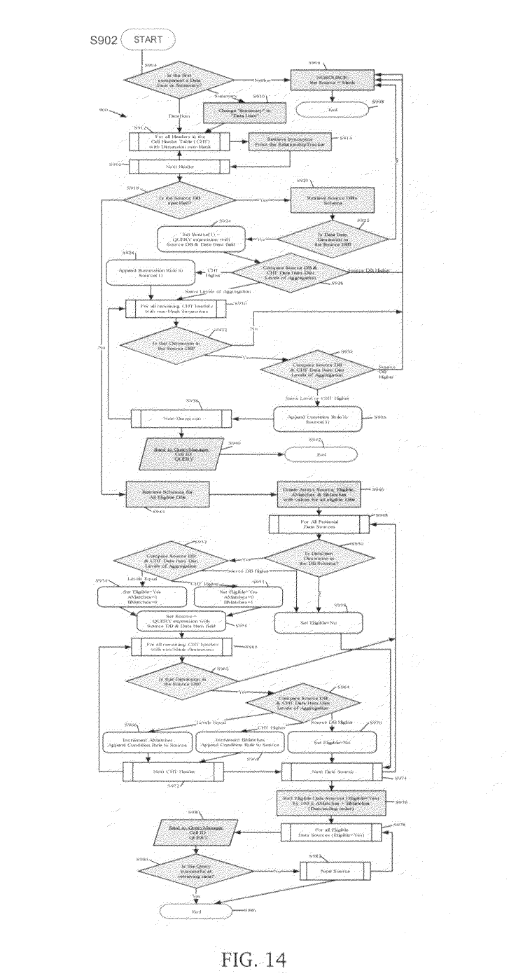

FIG. 14 is a flowchart showing the process 900 for determining a data source according to an exemplary embodiment of the present invention. The process 900 starts in step S902, and proceeds to step S904, where it is determined whether the first component attribute in the cell header table is a Data Item or a Summary. If neither, the process 900 continues to step S906, where the source is set equal to blank, meaning that the data source can not be determined. If it is determined that the first component attribute is Summary, the process 900 proceeds to step S910, where Summary is replaced with Data Item. If it is determined in step S904 that the first component attribute is Data Item, or after Summary is changed to Data Item in step S910, the process 900 continues to step S912, where a header attribute having a corresponding non-blank dimension attribute is selected, and in step S914, synonyms corresponding to the selected header are retrieved from the relationship manager 3020. In step S916, another header attribute having a corresponding non-blank dimension attribute is selected, and the process iterates through steps S912 through S916 until synonyms are retrieved for all header attributes having corresponding non-blank dimension attributes.

The process 900 then continues to step S918, where it is determined whether the source DB is specified. If so, the process continues to step S920, where the source DB's schema is retrieved from the database manager 2030. The process 900 then continues to step S922, where it is determined whether the dimension of the Data Item is in the source DB. If so, the process 900 continues to step S924, where the first element in the source array is set equal to a QUERY expression with the source DB and Data Item field. Otherwise, the process 900 jumps back to step S906, where the source is set equal to blank, meaning the source can not be determined.

From step S924, the process 900 continues to step S926, where the levels of aggregation of the source DB and cell header table Data Item dimension are compared. If the level of aggregation of the Data Item is higher than that of the source DB, the process 900 continues to step S928, where the summation rule used to aggregate the data in the source DB to reach the appropriate level of aggregation is appended to the first element in the source array. If the source DB level of aggregation is higher than that of the Data Item, the process 900 jumps back to step S906, where the source is set equal to blank. If the Data Item and the source DB have the same levels of aggregation, the process 900 proceeds to step S930, where one of the remaining headers having a corresponding non-blank dimension attribute is selected, and at step S932, it is determined whether that dimension attribute is in the source DB. If the dimension attribute is not in the source DB, the process 900 jumps back to step S906, where the source is set to blank. Otherwise, the process 900 continues to step S934, where the levels of aggregation of the source DB and the dimension for the corresponding header are compared.

In step S934, if the level of aggregation of the source DB is higher than that of the corresponding header dimension, the process 900 jumps back to step S906, where the source is set to blank. If the source DB and the corresponding header dimension have the same levels of aggregation, or the corresponding header dimension has a higher level of aggregation, the process 900 continues to step S936, where the condition rule is appended to the first element in the source array. Examples of a condition rule include “Town=Springfield” and “Year=2006”. In some cases, where the cell header table includes a time component, the entry into the source array must be converted to a specific time period so that all of the necessary information is made available to properly query a database. In this regard, a conversion rule may be used to reformat the time component. For example, as shown in FIG. 2E, the cell header table 32 includes the header “YTD”, which is a time component having a time dimension. In this example, a conversion rule is used to input the proper time period, “date between(“1/1” and today))”, into the source array 34.

From step S936, the process 900 continues to step S938, where another header having a non-blank dimension is selected and the process 900 iterates through steps S930-S938 until all headers having a non-blank dimension have been evaluated.

After the source array has been determined by evaluating all the headers having non-blank dimensions, the process 900 continues to step S940, where the cell ID of the cell header table and the QUERY expression in the source array are sent to the query manager 204. The process 900 then ends in step S942.

In step S918, if it is determined that the source DB is not specified in the cell header table, the process 900 continues to step S944, where the schemas for all potential source databases are retrieved. At this point in the process 900, all the potential source databases must be evaluated to determine whether any of these databases can be used to extract the necessary data. In this regard, a potential source database must have the same dimension as the headers in the cell header table and the same or lower level of aggregation than that of the Data Item dimension in order for that database to be useful to extract the necessary data.

From step S944, the process 900 continues to step S946, where an unpopulated eligibility array is created for each potential database. Each unpopulated eligibility array contains an Eligible field, an AMatches field and a BMatches field. These fields will be further defined below.

From step S946, the process 900 continues to step S948, where a potential database is selected for further evaluation. Then, in step S950, it is determined whether the Data Item dimension in the cell header table is in the selected eligible database schema. If not, the process continues to step S958, where the Eligibility field for that particular database is set to “No”, and the process 900 jumps to step S974, where another potential database is selected for evaluation.

If it is determined in step S950 that the Data Item dimension is in the selected eligible database schema, the process 900 continues to step S952, where the level of aggregation of the potential source database is compared to the level of aggregation of the Data Item dimension. If it is determined in step S952 that the potential source database has a higher level of aggregation than that of the Data Item, the process 900 continues to step S958, where the Eligibility field for that particular database is set to “No”, and another potential database is selected in step S974. An AMatch relates to a situation in which the potential database and the Data Item dimension have the same level of aggregation. A BMatch relates to a situation in which the level of aggregation of the Data Item dimension is higher than the level of aggregation of the potential database. Thus, if it is determined in step S952 that the Data Item dimension has the same level of aggregation than that of the potential database, the process 900 continues to step S954, where the Eligibility field for that particular database is set to “Yes”, the AMatches field is set to “1” and the BMatches field is set to “0”. Similarly, if it is determined in step S952 that the Data Item dimension has a higher level of aggregation than that of the potential database, the process 900 continues to step S955, where the Eligibility field for that particular database is set to “Yes”, the AMatches field is set to “0” and the BMatches field is set to “1”. From either steps S954 or S955, the process 900 continues to step S956, where the source is set equal to the QUERY expression with the eligible source database and Data Item field.

From step S956, the process 900 continues to step S960, where one of the remaining headers having a corresponding non-blank dimension is selected, and it is determined in step S962 whether the dimension is in the potential source database. If not, the process 900 jumps to step S974, where another potential database is selected. If it is determined in step S962 that the dimension is in the potential database, the process 900 continues to step S964, where the levels of aggregation of the potential source database and the dimension of the corresponding header are compared. If it is determined in step S964 that the level of aggregation of the potential source database is higher than that of the header dimension, the process 900 continues to step S970, where the Eligibility field of the eligibility array is set to “No”, and another potential source database is selected for evaluation in step S974. If it is determined in step S964 that the level of aggregation of the header dimension is higher than that of the potential source database, the process 900 continues to step S968, where the BMatches field in the eligibility array is incremented and the condition rule is appended to the source. If it is determined that the header dimension and the potential source database have the same levels of aggregation, the process 900 continues to step S966, where the AMatches field in the eligibility array is incremented and condition rule is appended to the source. As in step S936, to properly query a database, a conversion rule may be used to append specific time information to the source if there is a time component.

From either steps S966 or S968, the process 900 continues to step S972, where another header is selected for evaluation. After all headers have been evaluated for a potential source database, the process continues to step S974, where another potential source database is selected to determine whether that database can be used to extract the necessary data and/or to determine the number of AMatches and BMatches for that database. After all potential databases have been evaluated, the process 900 continues to step S976, where a weighting value “100×AMatches+BMatches” is determined for each source database having a corresponding Eligibility field set to “Yes”. These databases are then sorted based on the weighting values, with the database having the highest weighting value being ranked first.

The process 900 then continues to step S978, where a database having a corresponding Eligibility field set to “Yes” is selected, and in step S980, the cell ID of the cell header table and the QUERY expression is sent to the query manager 3040. Then, in step S984, it is determined whether the query is successful in retrieving data from the database. If not, the process continues to step S982, where another database having a corresponding Eligibility field set to “Yes” is selected, and the process 900 iterates through steps S978-S982, until a database is encountered which is able to successfully retrieve data. If no such database is encountered, the process ends at step S986. Alternatively, once the data is successfully retrieved, the process 900 ends at step S986.

FIG. 15 is a flowchart showing the process 1000 for determining format and sending to display manager 3010 according to an exemplary embodiment of the present invention. The process 1000 starts in step S1002, and continues to step S1004, where a non-blank “format” component in the cell header table is selected and it is determined in step S1006 whether display type, decimals, color, special formats or scaling have already been set. If so, the process 1000 continues to step S1008, where the next non-blank “format” component in the cell header table is selected. The process 1000 then continues to step S1010, where the cell ID, source and format are sent to the display manager 3010.

If it is determined in step 1006 that the display type, decimals, color, special formats or scaling have not been set, the process 1000 continues to step S1012, where the “format” component is appended to include the necessary format information.

Now that the preferred embodiments have been shown and described in detail, various modifications and improvements thereon will be readily apparent to those skilled in the art. Accordingly, the spirit and scope of the present invention is to be construed broadly and be limited only by the appended claims, and not by the foregoing specification.

What is claimed is:

1. A method for automatically generating target information within an electronic document comprising the steps of:
retrieving term-based identifying information from the electronic document that specifies the target information to be generated;
accessing rules associated with generation of the target information based on the retrieved term-based identifying information;
analyzing the identifying information and the rules to identify a type of target information to be generated and to determine a formula that uses underlying data to generate the target information;
automatically generating data source instructions based on the type of target information to be generated and the formula; and
automatically processing the data source instructions to generate the target information within the electronic document.

2. The method of claim 1, further comprising determining a preferred source of the underlying data, the step of automatically generating data source instructions being also based on the preferred source of underlying data.

3. The method of claim 2, wherein the step of determining the preferred source of the underlying data comprises:
accessing metadata from one or more potential sources of the underlying data; and
analyzing the metadata to identify the preferred source of the underlying data;

4. The method of claim 1, wherein the electronic document is a spreadsheet and the identifying information comprises at least one of a row header and a column header from the spreadsheet.

5. The method of claim 1, wherein the rules comprise one or more of following: an equation, a data condition, format instructions, scaling instructions, unit of measure conversions and synonym rules.

6. The method of claim 1, wherein the preferred source of the underlying data is located on a webpage or database accessed through the Internet.

7. The method of claim 1, wherein the preferred source of the underlying data is a database.

8. The method of claim 1, further comprising automatically generating an identification code corresponding to the term-based identifying information and the generated data source instructions.

9. The method of claim 8, further comprising storing the generated identification code and its corresponding term-based identifying information and generated data source instructions so as to be accessible to generate data source instructions for generating other target information within the electronic document that has the same term-based identifying information.

10. The method of claim 3, wherein the step of analyzing the metadata to identify a preferred source of the underlying data comprises prioritizing the one or more potential sources of underlying data based on likelihood of providing appropriate underlying data.

11. The method of claim 10, wherein the step of prioritizing comprises determining whether data in each of the potential sources of underlying data is at a required level of aggregation.

12. The method of claim 10, wherein the step of prioritizing comprises determining whether data in each of the potential sources of underlying data can be aggregated to obtain a required level of aggregation.

13. The method of claim 5, wherein the rule comprises an equation, and the equation applies to a particular context.

14. The method of claim 5, wherein the rule comprises an equation, and the equation applied to a particular scenario.

15. A computer readable medium having computer executable instructions for performing a method for automatically generating target information within an electronic document comprising the steps of:
retrieving term-based identifying information from the electronic document that specifies the target information to be generated;
accessing rules associated with generation of the target information based on the retrieved term-based identifying information;
analyzing the identifying information and the rules to identify a type of target information to be generated and to determine a formula that uses underlying data to generate the target information;
automatically generating data source instructions based on the type of target information to be generated and the formula; and
automatically processing the data source instructions to generate the target information within the electronic document.

16. The computer readable medium of claim 15, further comprising determining a preferred source of the underlying data, the step of automatically generating data source instruction being also based on the preferred source of underlying data.

17. The computer readable medium of claim 16, wherein the step of determining a preferred source of the underlying data comprises:
accessing metadata from one or more potential sources of the underlying data; and
analyzing the metadata to identify the preferred source of the underlying data;

18. The computer readable medium of claim 15, wherein the electronic document is a spreadsheet and the identifying information comprises at least one of a row header and a column header from the spreadsheet.

19. The computer readable medium of claim 15, wherein the rules comprise one or more of following: an equation, a data condition, format instructions, scaling instructions, unit of measure conversions and synonym rules.

20. The computer readable medium of claim 15, wherein the preferred source of the underlying data is located on the Internet.

21. The computer readable medium of claim 15, wherein the preferred source of the underlying data is a database.

22. The computer readable medium of claim 15, further comprising automatically generating an identification code corresponding to the term-based identifying information and the generated data source instructions.

23. The computer readable medium of claim 22, further comprising storing the generated identification code and its corresponding term-based identifying information and generated data source instructions so as to be accessible to generate data source instructions for generating other target information within the electronic document that has the same term-based identifying information.

24. The computer readable medium of claim 17, wherein the step of analyzing the metadata to identify a preferred source of the underlying data comprises prioritizing the one or more potential sources of underlying data based on likelihood of providing appropriate underlying data.

25. The computer readable medium of claim 24, wherein the step of prioritizing comprises determining whether data in each of the potential sources of underlying data is at a required level of aggregation.

26. The computer readable medium of claim 24, wherein the step of prioritizing comprises determining whether data in each of the potential sources of underlying data can be aggregated to obtain a required level of aggregation.

27. The computer readable medium of claim 19, wherein the rule comprises an equation, and the equation applies to a particular context.

28. The computer readable medium of claim 19, wherein the rule comprises an equation, and the equation applied to a particular scenario.

29. A system for automatically generating target information within an electronic document, comprising:
a header manager that retrieves term-based identifying information from the electronic document that specifies the target information to be generated;
a term manager that accesses rules associated with generation of the target information based on the retrieved term-based identifying information;
a derivation engine that analyzes the identifying information and the rules to identify a type of target information to be generated and to determine a formula that uses underlying data to generate the target information;
a query manager that automatically generates data source instructions based on the type of target information to be generated and the formula; and
a display manager that automatically processes the data source instructions to generate the target information within the electronic document.

30. The system of claim 29, further comprising a database manager that accesses one or more databases to retrieve underlying data based on the data source instructions.

31. The system of claim 30, wherein the database manager is an element of the query manager.

32. The system of claim 29, further comprising a relationship manager that stores relationship rules among the underlying data.
